(19) United States
(12) Patent Application Publication
(10) Pub. No.: US 2010/0265057 A1
(43) Pub. Date: Oct. 21, 2010

(54) ATTENTIVE DEVICE APPLIED TO VEHICLES

(76) Inventor: Chung-Yu YEH, Renwu Township (TW)

Correspondence Address: Dr. BANGER SHIA;Patent Office of Bang Shia, 102 Lindencrest Ct, Sugar Land, TX, 77479-5201, US

(21) Appl. No.: 12/752,695

(22) Filed: Apr. 1, 2010

(30) Foreign Application Priority Data
Apr. 17, 2009 (TW) 098206405

(51) Int. Cl. B60Q 1/50

(52) U.S. Cl. 340/467

(57) ABSTRACT

An attentive device applied to vehicles includes a controlling mechanism and a display panel connected thereto. Wherein, the display panel is disposed on a body of the vehicle and includes LEDs. Further, the LEDs are divided into at least two effect zones that are thence connected to the controlling mechanism. Either of the effect zones is arranged for a performance of a particular symbol, so that the LEDs in one of the effect zone would shine for exposing the symbol and preferably those in the other effect zone would extinguish or flash in case that a command is generated and transmitted by the controlling mechanism, which gives the latter drivers and passersby an impressive warning effect and efficiently promotes the driving safety by increasing the identification regarding to the status of the front driver.

### BACKGROUND OF THE INVENTION

1. Field of the Invention

The present invention relates to a warning device, particularly to one adapted for the transportation, like vehicles.

2. Description of the Related Art

FIGS. 1 and 2 disclose a conventional warning device 1 applied to motorcars and motorcycles. The conventional device 1 includes a controlling mechanism 11 and a display panel 12 connected to the controlling mechanism 11; wherein, the display panel 12 is formed by a plurality of LEDs 121 and is located on stoplights 21 of the car or the motorcycle. Further, a power 22 provides the display panel 12 with electricity. The controlling mechanism 11 has a circuit board 111 linking with the display panel 12 and an input unit 112 connected to the board 111. The input unit 112 could be activated either by a brake pedal 23 of the car 2 or a handle brake of the motorcycle, and the foregoing brake pedal 23 is adopted as an example in the description.

In a normal driving in daytime, the power would not provide the electricity to the lights of the car 2, so the LEDs 121 of the display panel 12 would not flash or shine. Whereas, should the driver needs to brake, he or she would tread the brake pedal 23. The aforementioned would render an input signal generated from the input unit 112, and the signal serves commanding the display panel 12 to flash all the LEDs 121 through the circuit board 111. When in a night driving, the power 22 is substantially turned on regarding to a safety concern and the LEDs 121 on the display panel 12 hence present flashes. However, due to that there is small current transmitted to the display panel 12, the display panel 12 can merely show a faint light. Alternatively, the display panel 12 would not flash all the LEDs for a caution until the driver is subjected to an unexpected situation and needs to tread the brake pedal 23.

For promoting a safety driving behavior pursuant to the regulation stipulated by Road Traffic ACT, the Government specifies that any sold cars, shown in FIGS. 2 and 3, have to install a third taillight 24 at the rear side of the car and that the stoplights 21 of the vehicle 2 requires to strength the brightness related to braking operation, hence reminding the latter driver to be aware of the status of the preceding car. Although the brightness of the stoplights 21 are promoted, the shield covering the stoplights 21 would be readily wrapped by dust or the brightness of bulbs inside the stoplights 21 would readily become less variable when in a long-term of using.

Accordingly, referring to FIG. 3, the car 2 having a third taillight 24 with multiple LEDs is disclosed. Wherein, the LEDs substantially create different reminders 3, such as symbols indicated by Δ, ◯, —, ←, → or some other slogans like STOP. In terms of the application to the motorcycle (not shown), the taillight thereof could be decorated by an assortment of symbols and be set by bulbs with higher brightness for expectantly reminding the latter drivers. Whereas, no matter how the aforementioned device applied to the car 2 or the motorcycle, it in fact distinguishes from an inventive concept of the instant invention dedicated to promoting the configuration of the stoplights and attaining a preferable warning effect.

### SUMMARY OF THE INVENTION

The object of the present invention is to provide an attentive device applied to vehicles, which attains a high identification and provides a preferable warning effect for the latter driver so as to improve the frequent accidents and increase the driving safety.

The present invention essentially comprises a controlling mechanism and a display panel connected to the controlling mechanism; wherein, the display panel comprises multiple LEDs disposed thereon; characterized in that the LEDs are divided into at least two effect zones and the effect zones connected to the controlling mechanism; either the effect zone is arranged by a particular symbol, so that when a command is transmitted, the LEDs in one effect zone would be shined to expose the symbol to the display panel for impressively drawing the latter driver's and passersby's attention. Thus, the present invention efficiently increases the identification regarding to the status of the preceding car so that the latter driver would keep a safe distance away from the preceding driver, which could preferably improve the occurrence of accidents and promotes the driving safety.

An attentive device applied to vehicles in accordance with the present invention comprises a controlling mechanism and a display panel connected thereto; wherein, the display panel is disposed on a body of the vehicle and comprised of a plurality of LEDs; the vehicle has a power able to provide the display panel with electricity; the controlling mechanism has a programme unit linking to the display panel and an input unit connected to the programme unit; the input unit creates a command and sends the command to the programme unit to allow a presence of brake warning on the display unit driven by the programme unit. Particularly, the LEDs is divided into at least two effect zones and the effect zones connected to the programme unit; either of the effect zones is arranged in a way representative of a particular symbol; a transmission of the command to the programme unit shining the LEDs in one of the effect zones to efficiently expose the particular symbol to the display panel for a preferable caution.

Preferably, one of the effect zones performs an X-shaped contour indicative of the symbol.

Preferably, the programme unit of the controlling mechanism further links with an actuating member.

Preferably, the programme unit of the controlling mechanism further links with one sensor.

Preferably, the LEDs in the other effect zone extinguishes while transmitting the command.

Preferably, the LEDs of the other effect zone flashes while transmitting the command.

The advantages of the present invention over the known prior arts will become more apparent to those of ordinary skilled in the art upon reading the following descriptions in junction with the accompanying drawings.

### BRIEF DESCRIPTION OF THE DRAWINGS

FIG. 1 is a flowchart showing the connection of the conventional device;

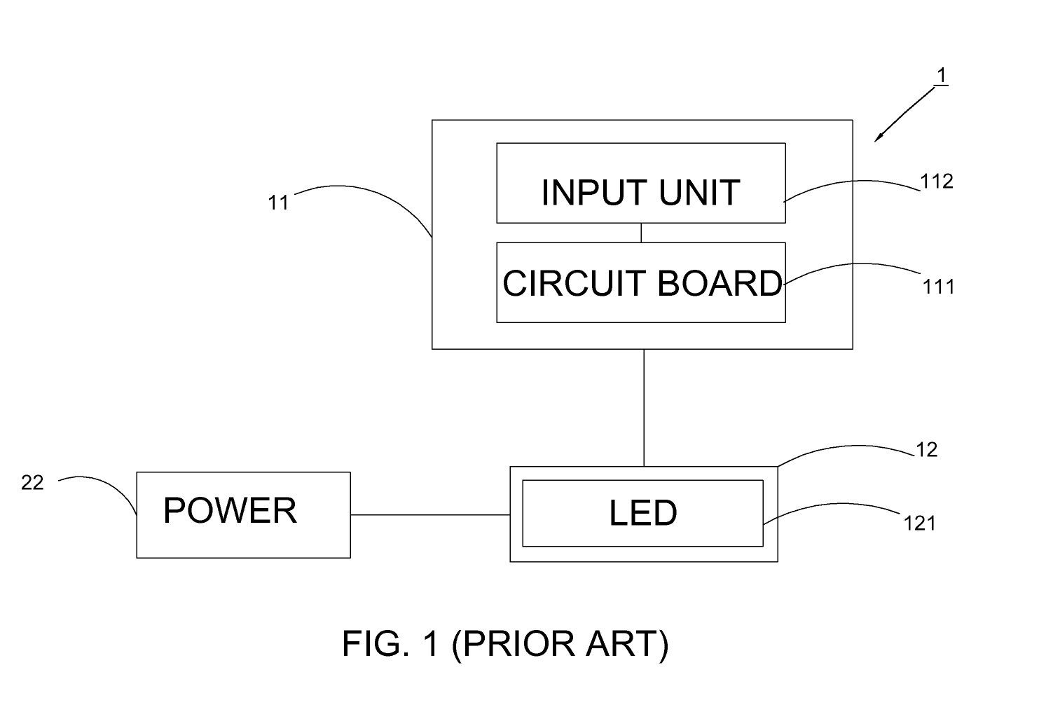

FIG. 2 is a schematic view showing the installation of the conventional device on the vehicle;

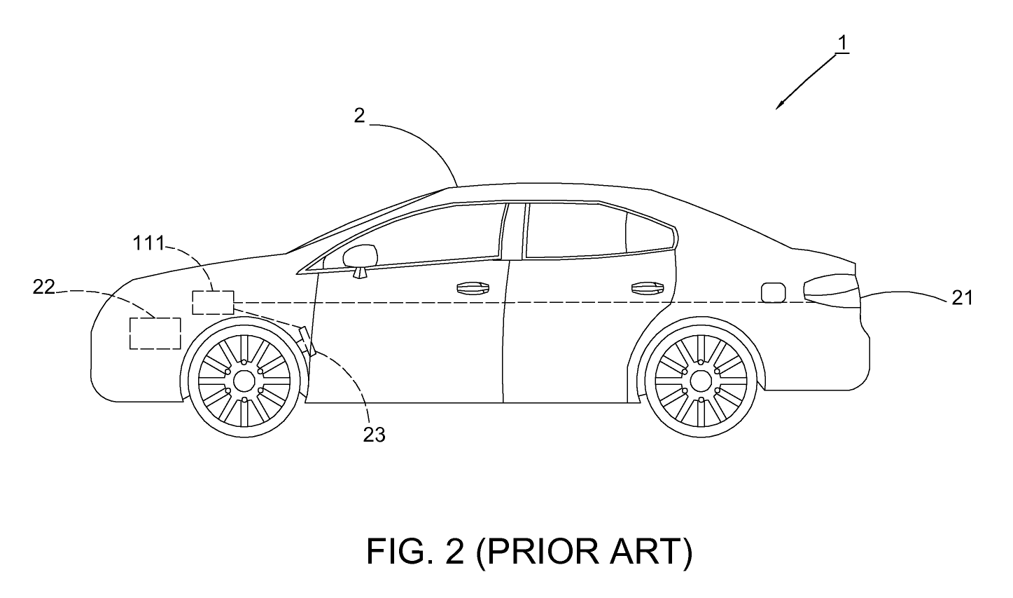

FIG. 3 is a schematic view showing a third taillight disposed on the conventional vehicle;

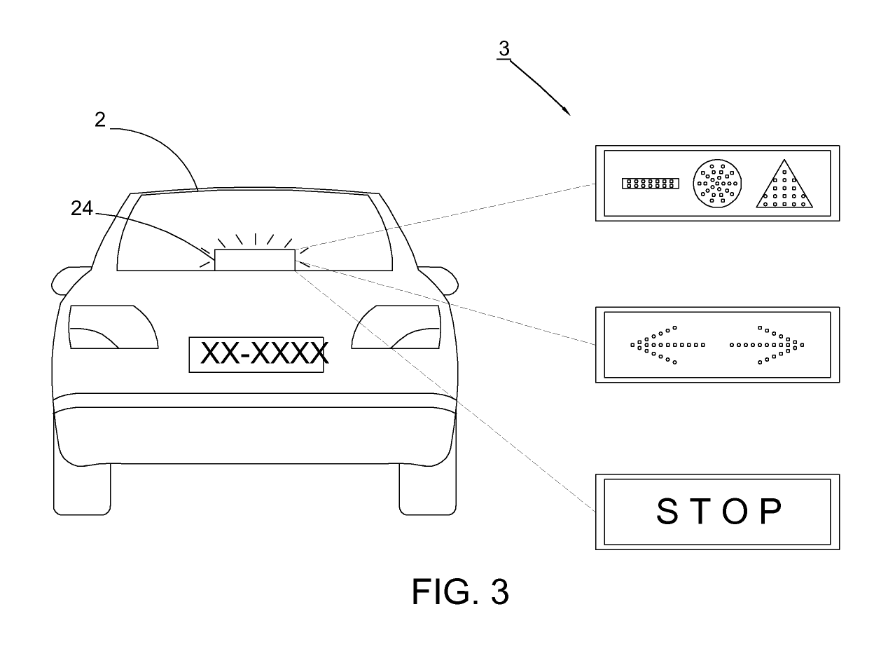

FIG. 4 is a flowchart showing a first preferred embodiment of the present invention;

FIG. 5 is schematic view showing the installation of the present invention on a car;

FIG. 6 is a diagram showing the concatenation of the effect zone of the present display panel;

FIG. 7 is flowchart view showing a second preferred embodiment of the present invention;

FIG. 8 is a schematic view showing the installation of the second preferred embodiment on a car;

FIG. 9 is a flowchart showing a third preferred embodiment of the present invention; and

FIG. 10 is a schematic view showing the installation of the third preferred embodiment on a motorcycle; and

FIG. 11 is a schematic view showing a fourth preferred embodiment mounted on an electronic bicycle.

### DETAILED DESCRIPTION OF THE PREFERRED EMBODIMENTS

Before the present invention is described in greater detail, it should be noted that the like elements are denoted by the same reference numerals throughout the disclosure.

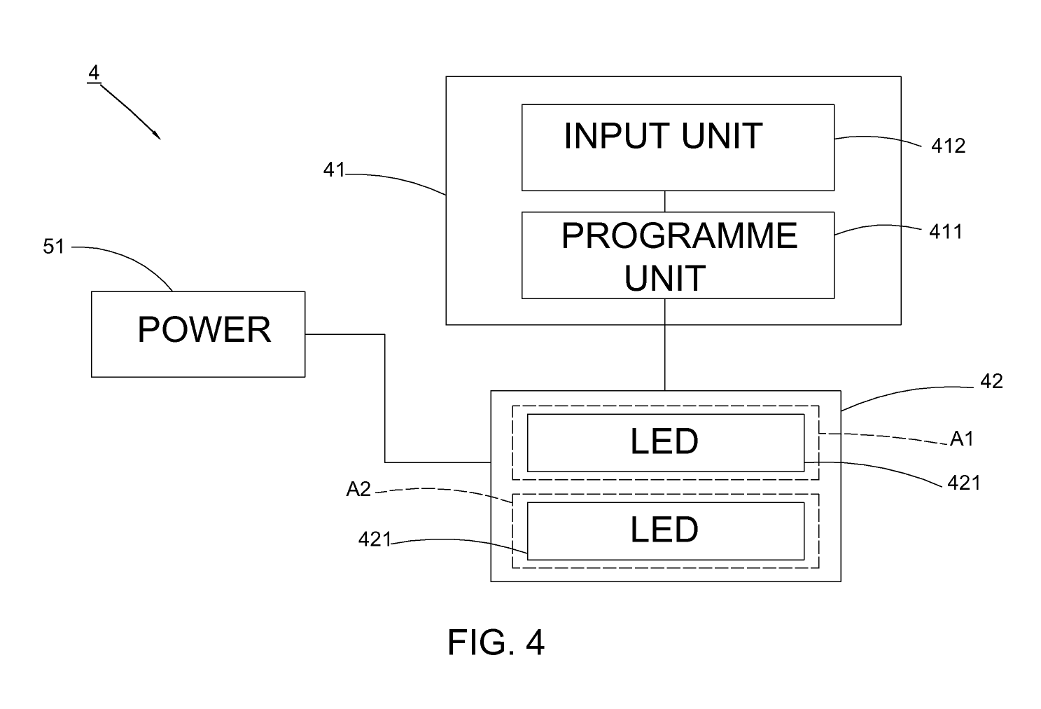

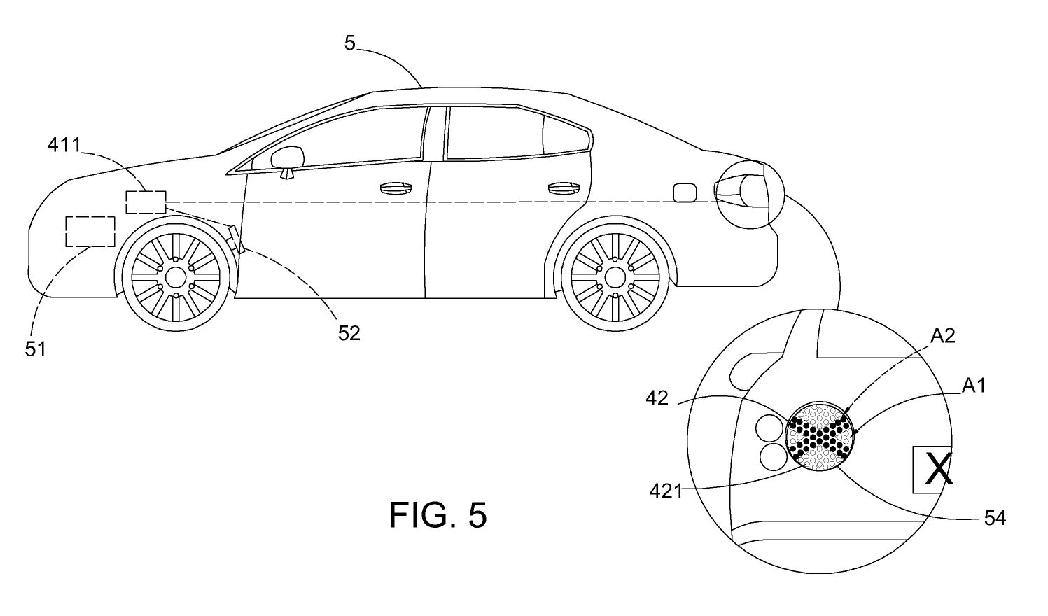

FIGS. 4 and 5 show a first preferred embodiment of the present invention. An attentive device 4 applied to vehicles 5 in accordance with the first embodiment comprises a controlling mechanism 41 and a display panel 42 connected thereto; wherein, the vehicle 5 can be a motorcar/car, a motorcycle, an electronic bicycle, etc. and herein the car 5 is described as follows. Further, the controlling mechanism 41 has a programme unit 411 linking to the display panel 42 and an input unit 412 connected to the programme unit 411. The programme unit 411 is properly disposed on the vehicle 5. In addition, the input unit 412 triggered by a pressing behavior creates a command and sends the command to the programme unit 411 to allow a presence of brake warning on the display unit 42 driven by the programme unit 411. In the preferred embodiment, the means for triggering the input unit 412 is disposed on a brake pedal 52 of the car 5.

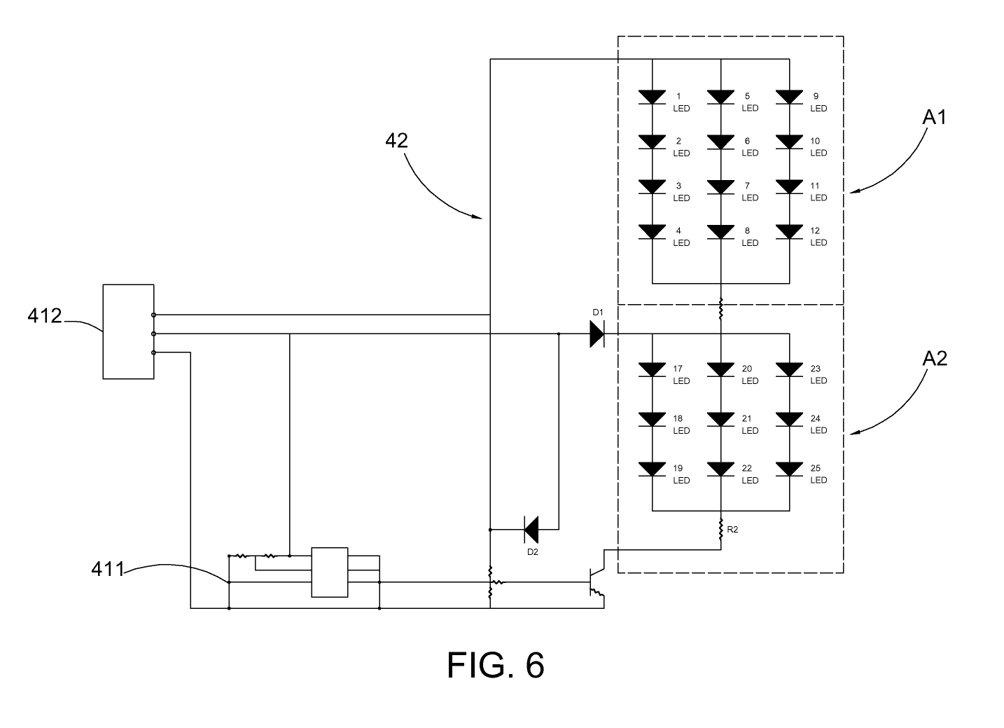

The vehicle 5 has a power 51 capable of providing the display panel 42 with electricity. The display panel 42 is disposed on a body of the vehicle 5 and comprised of a plurality of LEDs 421. Particularly, the LEDs 421 are divided into at least two effect zones A1,A2 and the effect zones A1,A2 connected to the programme unit 411 as well. Either effect zone A1 or A2 is arranged in a way indicative of a particular symbol; the allocation of LEDs in these two zones A1, A2 is illustrated by FIG. 6 or by other appropriate dispositions. Accordingly, the transmission of the command from the input unit 412 to the programme unit 411 permits an extinction of the LEDs 421 in one effect zone A1 and shines the LEDs 421 in the other effect zone A2 to substantially expose the particular symbol. Further in connection with the location of the display panel 42, it could be set at a conspicuous place, such as at two sides of the car, on indicating side lights, on stoplights, etc. In the preferred embodiment, the display panel 42 is preferably disposed on the stoplights 54 of the car.

In the preferred embodiment, the symbol of the effect zone A2 is preferably performed by an X-shaped contour. It is noted that the inventor has carried out a survey of the braking performance of the vehicles and also made an interview with the party who was in a car accident and was punished by any alcoholic driving behaviors. Furthermore, the subject inventor experiments on the comparisons between the figures and slogans presented on the subject stoplights and current market stoplights. For general interviewees, they acknowledged that they cannot make an immediate judgment and accurately behave when they firstly saw the stoplights of the front driving car flashing, and they reached a consensus that they still needs a further and a detailed observation on other light indicators for identifying the status of the front car. The aforementioned situation would be frequently incurred by alcoholic drivers, which rises the occasion of car accidents without doubt. In contrast, the X-shaped contour performed by the subject display panel 42 is much easily identified by the interviewees, namely without a further consideration or an observation, and they can instantly react to the driving status of the car in front of them and give a brake in light of the flashed or shined stoplights. Thus, the subject arrangement of the symbol as mentioned above is substantially functioned.

Referring to FIGS. 4 and 5, the programme unit 411 of the controlling mechanism 41 connects to the brake pedal 52 of the car 5. The brake pedal 52 herein is deemed as the input unit 412. While treading the brake pedal 52, the programme unit 411 triggers the display panel 42 to react. That is, in case that a driver is subjected to an unexpected affair while driving in the daytime, he or she could step on the brake pedal 52 for creating a command. When the programmed unit 411 receives the command, it thence synchronically controls the originally non-flashed LEDs 421 to act. In this connection, only the LEDs 421 of the effect zone A2 would be shined into X shape, and the latter driver as well as passersby are fully and immediately warned by the X-shaped symbol so as to realize the driving status of the car in front of them. Therefore, the latter driver could cautiously keep a safety distance away from the preceding car and avoid chasing after it, thereby efficiently increasing the driving safety and decrease accidents.

In contrast, while driving in the night, all the LEDs 421 would become flashed as a result of the activated power 51. In this manner, when the target driver treads on the brake pedal 52 for generating the command, the programme unit 411 would accordingly extinguish the LEDs 421 of the effect zone A1 and then reinforce the X-shaped shine of the LEDs 421 of the effect zone A2, so as not only emphasize the driving status of the car 5 but explicitly remind the latter car driver and passersby to be carefully aware of the status of the preceding car 5.

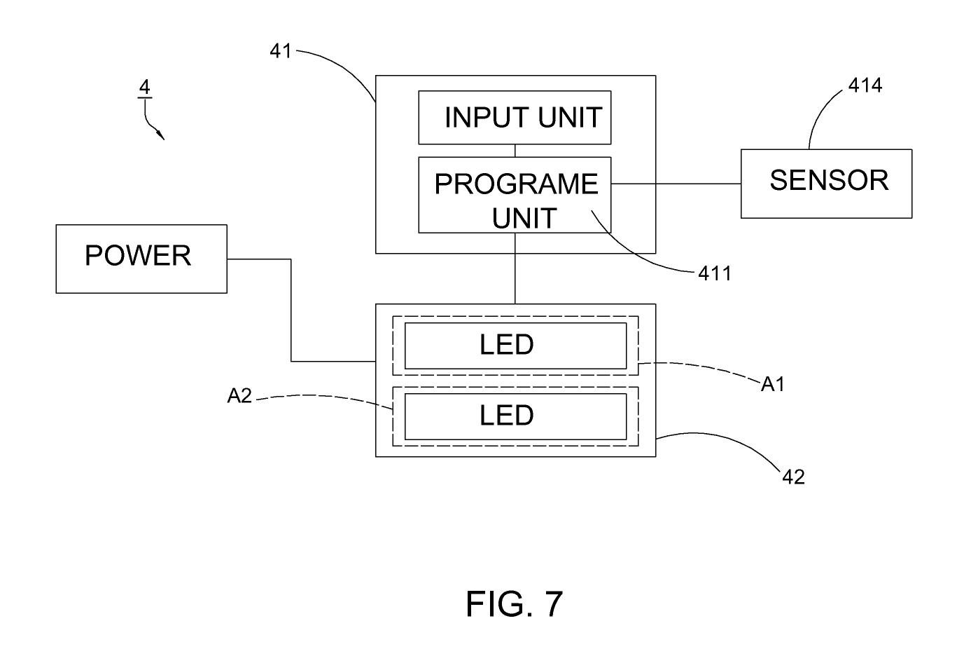

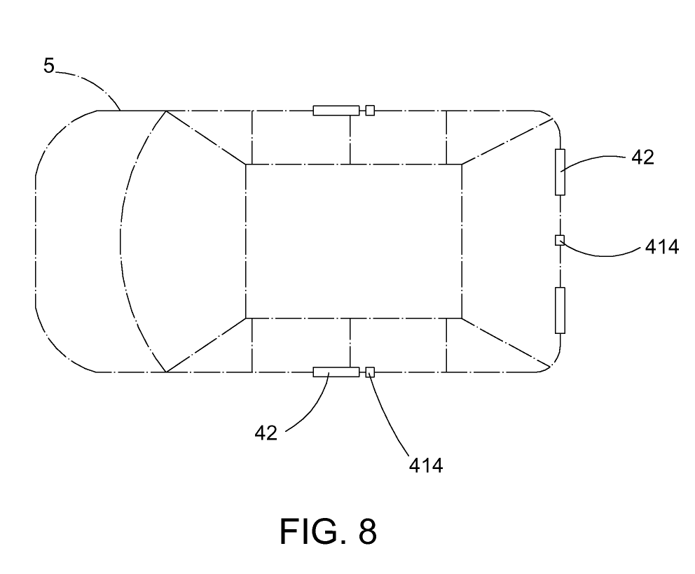

Referring to FIGS. 7 and 8 show a second preferred embodiment of the present invention. The attentive device 4 still includes a controlling mechanism 41, a display panel 42, and other requisite elements for the same objects and purposes. In particular, the programme unit 411 of the controlling mechanism 41 at least links with a sensor 414. The sensor 414 could be an ultrasonic sensor, a radar sensor, or other appropriate sensors. The sensor 414 defines a detecting scope, and the sensor 414 is activated to create a command if any obstructions get into the detecting scope. The command would thence be send to the programme unit 411. In this preferred embodiment, the sensor 414 is mounted on two sides and the tail of the target car 5, on which the display panel 42 is concurrently disposed. In operation, as long as the obstructions, like latter cars, are driven to the detecting scope of the sensor 42, the sensor 42 would be triggered to lead to the programme unit 411 activating an incessant shine or an alternating flash of the effect zones A1 and A2 of the display panel 42. Therefore, the latter cars adjacent to the target car 5 could get a precise reminder and keep an adequate driving distance away therefrom, thence preventing the unexpected crash and increasing the safety.

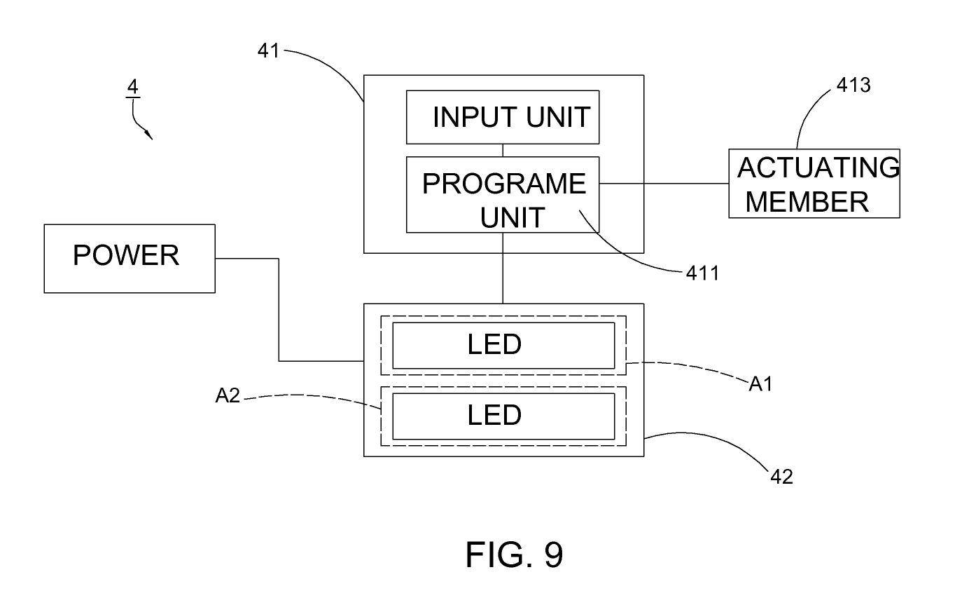

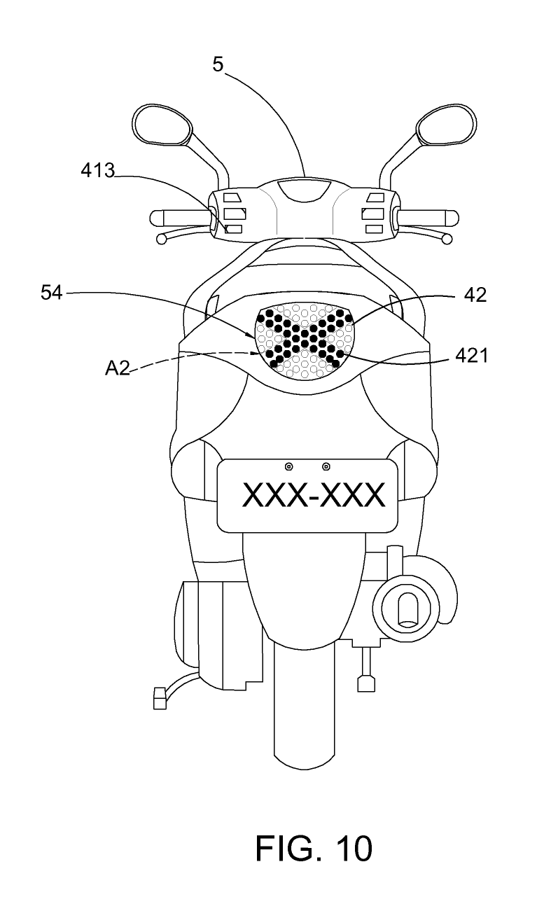

Referring to FIGS. 9 and 10 show a third preferred embodiment of the present invention. Herein, the vehicle 5 is adopted by a motorcycle. The attentive device 4 comprises a controlling mechanism 41, a display panel 42, and other requisite elements. The display panel 42 is preferably mounted on the stoplight 51 of the motorcycle 5. Particularly, the programme unit 411 of the controlling mechanism 41 further links with an actuating member 413. The actuating member 413 could be mounted at any places of the motorcycle, and which is herein mounted on the handlebar of the motorcycle 5. Further, the actuating member 413 connects to the programme unit 411, so that the programme unit 411 subjected to the command from the actuating member 413 would trigger the LEDs 421 of the effect zone A2 to impressively shine the X-shaped symbol.

Should the subject motorcycle is in malfunction while driving in the night, the driver could trigger the actuating member 413 to lead to the LEDs 421 of the effect zone A2 flashing incessantly and to render the stoplight 54 salient in the night. Therefore, the latter cars or passersby could plainly identify the subject motorcycle 5 with a caution for decreasing the occasion of crashing and increasing the safety concern.

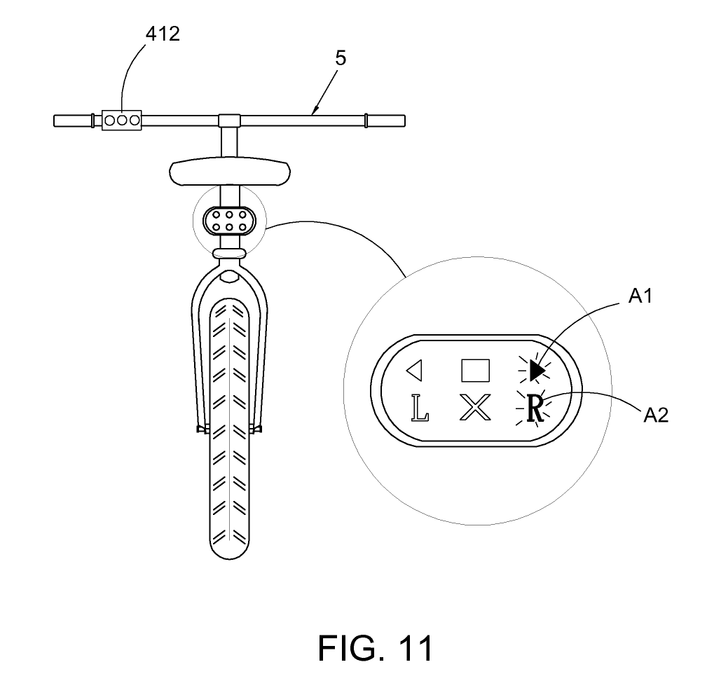

Referring to FIG. 11 shows a fourth preferred embodiment of the present invention. Herein, the vehicle 5 is adopted by an electronic bicycle. The attentive device 4 still comprises a controlling mechanism 41, a display panel 42, and other requisite elements. Particularly, the two effect zones A1 and A2 are disposed at intervals and respectively formed by different symbols, such as an indicating slogan and a letter “R” indicative of RIGHT. Accordingly, while turning right, the display panel 42 driven by the command of the input unit 412 makes the effect zone A1 blink and simultaneously makes the effect zone A2 bright, thereby achieving a dual performance for the latter car or passersby plainly identify the driving status of the front bicycle 5 and increasing the driving safety.

To sum up, the present invention takes advantage of the LEDs being divided into at least two effect zones that are thence connected to the controlling mechanism. The LEDs in one of the effect zone would substantially shine for exposing its indicated symbol and would extinguish those in the other effect zone when there is an input of command, which gives the latter vehicles and passersby an impressive warning effect and efficiently promotes a driving safety by increasing the identification regarding to the status of the preceding vehicle.

While we have shown and described the embodiment in accordance with the present invention, it should be clear to those skilled in the art that further embodiments may be made without departing from the scope of the present invention.

What is claimed is:

1. An attentive device applied to vehicles comprising a controlling mechanism and a display panel connected thereto; wherein, said display panel being disposed on a body of said vehicle and comprised of multiple LEDs; said vehicle having a power able to provide said display panel with electricity; said controlling mechanism having a programme unit linking to said display panel and an input unit connected to said programme unit; said input unit creating a command and sending said command to said programme unit to allow a presence of brake warning on said display unit driven by said programme unit;
Wherein, said LEDs being divided into at least two effect zones and said effect zones connected to said programme unit; Either of said effect zones being arranged in a way representative of a particular symbol; a transmission of said command to said programme unit shining said LEDs in one of said effect zones to efficiently expose said particular symbol to said display panel for a preferable caution.

2. The device as claimed in claim 1, wherein said effect zone performs an X-shaped contour indicative of said symbol.

3. The device as claimed in claim 1, wherein said programme unit of said controlling mechanism further links with an actuating member.

4. The device as claimed in claim 1, wherein said programme unit of said controlling mechanism further links with one sensor.

5. The device as claimed in claim 1, wherein said LEDs in said the other effect zone extinguishes while transmitting said command.

6. The device as claimed in claim 1, wherein said LEDs of said the other effect zone flashes while transmitting said command.
